(19) United States
(12) Patent Application Publication
(10) Pub. No.: US 2007/0057787 A1
(43) Pub. Date: Mar. 15, 2007

(54) Virtual display with motion synchronization

(76) Inventors: Rene P. Helbing, Palo Alto, CA (US); Gim Eng Chew, (US); Kee Yean Ng, (US); Thye Linn Mok, (US); Wooi Kin Goon, (US); Janet Bee Yin Chua, (US)

Correspondence Address: AVAGO TECHNOLOGIES, LTD., P.O. BOX 1920, DENVER, CO, 80201-1920, US

(21) Appl. No.: 11/225,928

(22) Filed: Sep. 13, 2005

(51) Int. Cl. G08B 13/00

(52) U.S. Cl. 340/565

(57) ABSTRACT

A virtual display with motion synchronization (“VDMS”) device using one or more arrays of light sources for displaying messages. The VDMS device may include a motion sensor to detect and measure movement of the VDMS device, and synchronization circuitry configured to synchronize the light emission of the individual light sources in the arrays with the movement of the VDMS device. The VDMS device may also include a self-contained power source and a control unit and interface that allow the user to program the messages that are displayed by the VDMS device, as well as memory that stores user messages.

### BACKGROUND OF THE INVENTION

Light emitting diodes (“LEDs”) are, in general, miniature semiconductor devices that employ a form of electroluminescence resulting from the electronic excitation of a semiconductor material to produce visible light. Initially, the use of these devices was limited mainly to display functions on electronic appliances and the colors emitted were red and green. As the technology has improved, LEDs have become more powerful and are now available in a wide spectrum of colors.

As LEDS have become smaller, brighter, and less expensive, they have been found in an ever increasing number of applications, particularly in applications related to displaying messages and information. An example of such a display device using LEDs is shown in FIG. 1.

FIG. 1 shows a schematic diagram of a display device that uses a line array of LEDs to display various messages. The display device includes a base 102, to which is attached a pendulum 104 (or wand) that is attached to the base by a pivot 106. The pendulum 104 has attached to it a line array of LEDs 108. Stored in the base 102 may be a small electric motor (not shown) that rotates the pendulum 104 about the pivot 106, back and forth, while at the same time, the LEDs 108 are driven by a power source (not shown) causing them to flash intermittently in a predetermined sequence. The rotation of the pendulum 104 creates a display area 110 in the form of a semicircle bounded by points 112, 114, and 116.

The display device 100 may be programmed to display various messages within the display area 110. For example, the display device may function as a clock, with the time and date displayed in the display area 110, as well as the current temperature. This is done by the rotation of the pendulum 104 while the LEDs 108 flash in a predetermined sequence. For example, if the pendulum 104 swings left to right about 50 times per second, the pendulum 104 will become invisible to the human eye. At the same time, the flashing LEDs 108 will spell out the desired message, which will be visible to the human eye.

According to the theory of persistence of vision, the retina of the human eye retains an image for a split second, and therefore, as the pendulum 104 rotates back and forth, the light emitted by the flashing LEDs 108 appears as a single image in the form of a message that may appear to be floating in space. This is analogous to a motion picture or TV screen that appears as a steady image when in fact it may be flickering at a rate of 24 to 30 times a second. Hence, devices such as the one shown in FIG. 1 are sometimes referred to as a “virtual display” or a “floating display.”

Unfortunately, when a device utilizes this type of pendulum movement to create the display area, the device is inefficient because the size of the display area is relatively small in relation to the size of the device, and therefore these types of devices are typically not very compact or portable. Also, another drawback of these types of devices is that they are stationary and cannot be used when they are in motion.

Therefore, there is a need for an improved virtual display device that has a larger display area without a corresponding increase in the device's size and weight. Additionally, there is a need for the device to be portable and also to be responsive to movement of the device itself.

### SUMMARY

A virtual display with motion synchronization (“VDMS”) device using one or more arrays of light sources for displaying messages is disclosed. The VDMS device may include a motion sensor to detect and measure movement of the VDMS device, and synchronization circuitry configured to synchronize the light emission of the individual light sources in the arrays with the movement of the VDMS device. The VDMS device may also include a self-contained power source and a control unit and interface that allow the user to program the messages that are displayed by the VDMS device, as well as memory that stores user messages.

In an example of operation, the VDMS device may be implemented in the form of a handheld light stick, with a line array of light sources positioned along the length of the VDMS device. The user may hold the VDMS device using an attached handgrip, and then may move the VDMS device in a sweeping motion or back and forth, with the VDMS device generating a message in the display area defined by the area swept by the VDMS device. The motion sensor in the VDMS device detects the velocity, acceleration, and the range of motion of the VDMS device, and the synchronization circuitry adjusts the size and intensity of the message displayed by the VDMS device in response to the movement of the VDMS device.

Other systems, methods and features of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. In the figures, like reference numerals designate corresponding parts throughout the different views.

FIG. 1 shows a schematic diagram of an example of an implementation of a conventional display device that utilizes a line array of LEDs to display various messages.

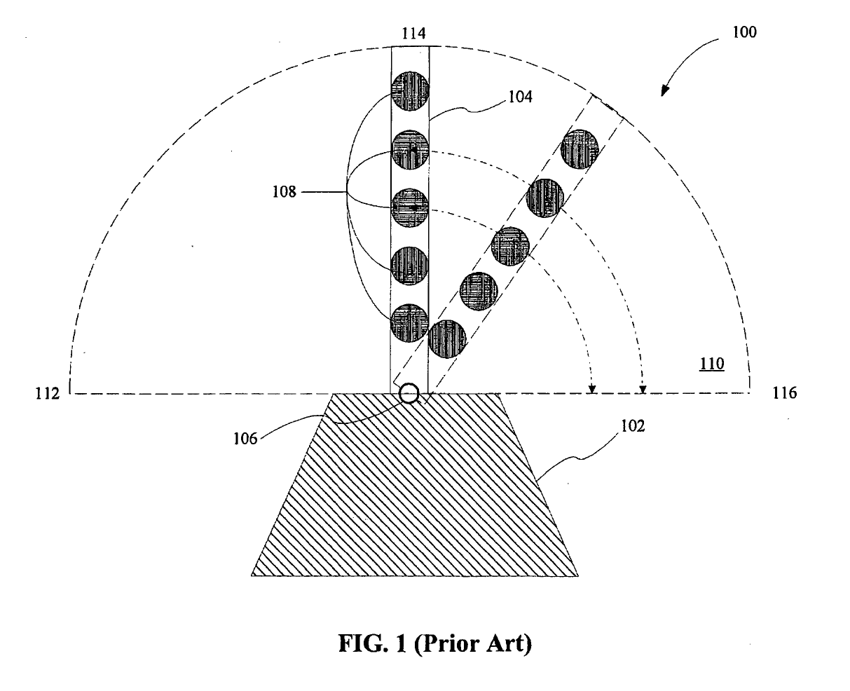

FIG. 2 shows a schematic diagram of an example of an implementation of a virtual display with motion synchronization (“VDMS”) device that includes a single line array of light sources for displaying messages in accordance with the invention.

### DETAILED DESCRIPTION

In the following description of the preferred embodiment, reference is made to the accompanying drawings that form a part hereof, and which show, by way of illustration, a specific embodiment in which the invention may be practiced. Other embodiments may be utilized and structural changes may be made without departing from the scope of the present invention.

In general, the invention is a virtual display with motion synchronization (“VDMS”) system configured to display a message using flashing light emitted by light emitting diodes (“LEDs”). The user of the VDMS system is able to generate a message within a display area by his movement of the VDMS device. Motion sensors in the VDMS device detect movement of the VDMS device and using synchronization circuitry, the VDMS device adjusts the frequency and intensity of the flashing of the LEDs so as to generate a message with predefined desired characteristics. Desired characteristics may include the content of the message displayed, the type, size, and color of the characters making up the message, as well as other features of the message, such as flashing or pulsating messages. As an example of operation, as the user moves the VDMS device over a wide area, the display area will increase with a larger message displayed in the display area. Additionally, the intensity of the displayed message may increase with an increase in the speed of the movement of the VDMS device.

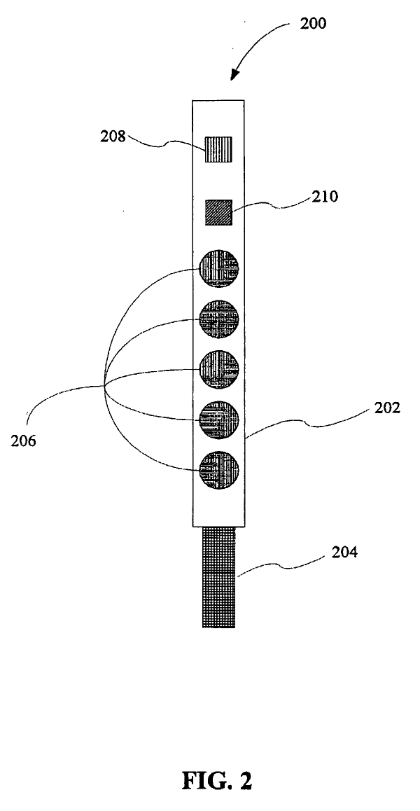

In FIG. 2, a schematic diagram of an example of an implementation of a virtual display with motion synchronization (“VDMS”) device 200 is shown in accordance with the invention. The VDMS device 200 includes a single line array of light sources for displaying messages. The VDMS device 200 includes a wand portion 202 and a handgrip portion 204. Within the wand portion 202, there is a single line array of LEDs, which may be of any of the various colors in which LEDs are available. For purposes of illustration, the VDMS device 200 is shown with a single line array of LEDs 206. However, the VDMS device 200 may also include a plurality of line arrays of LEDs as well as LEDs in other configurations, such as a bargraph, 7-segment, starburst, and dot matrix, or any combination of available LED configurations.

The VDMS device 200 may also include at least one motion sensor 208. As an example, the motion sensor 208 may be any commercialized micro-electro-mechanical systems (“MEMS”) inertial sensor, which has the capability to utilize human movement and gesture as inputs to electronic devices. This would include a low-g integrated-circuit (“IC”) accelerometer that senses acceleration in the planes of the x, y, and z axes, and which may be a single-axis, dual-axis, or triaxial device. Another type of MEMS inertia sensor is a rate gyroscope that measures the rate of rotation around the x, y, and z axes. Both types of devices output a digital signal that may be interfaced to a controller unit or microprocessor via a standard Serial Peripheral Interface (“SPI”) or a Universal Asynchronous Receiver/Transmitter (“UART”). Additionally, the motion sensor 208 may include both an MEMS IC accelerometer and a MEMS rate gyro.

Examples of low-g accelerometers are the ADXL 103 and 203 iMEMS® accelerometers produced by Analog Devices, Inc., of Norwood, Mass., the MMA6260Q acceleration sensor produced by Freescale Semiconductor, Inc., of Austin, Tex., the SMB triaxial accelerometer produced by Bosch Sensortec GmbH of Reutlingen, Germany, and similar devices. An example of a rate gyroscope with an SPI output is the ADIS16100 iMEMS® gyroscope produced by Analog Devices, Inc.

The motion sensor 208 may be in signal communication with synchronization circuitry 210 that receives signals from the motion sensor 208 and adjusts the flashing of the LEDs 206 accordingly. As an example, if the motion sensor 208 is a low-g accelerometer, it may be configured to sense when the wand portion 202 of the VDMS device 200 switches direction, e.g., the g-force along a particular axis will pass through zero. In this case, the synchronization circuitry 210 may alter the message being displayed by the VDMS device 200, e.g., by reversing the lettering displayed in the display area. As an example, a user of the VDMS device 200 may swing the VDMS device 200 back and forth overhead or up and down, on either side, and the motion sensor 208 will detect the motion and the synchronization circuitry 210 will automatically adjust the displayed messages in response to the signals generated by the human movement of the VDMS device 200.

The synchronization circuitry 210 may also include a microprocessor, microcontroller, controller, digital signal processor (“DSP”), application specific integrated circuit (“ASIC”), or programmable machine, or similar type of device and/or module, to process the input signals generated by the motion sensor 208, and the synchronization circuitry 210 may also be configured to receive control information and data via a wireless connection as well as through a wired data upload connection to the VDMS device 200, such as, for example, an Internet connection using a USB port and/or an Ethernet connection. The synchronization circuitry 210 may also include embedded software configured to create text messages and simple graphics in the display area, as well as memory (not shown) in which such messages and graphics may be stored for later use. The memory may also store software capable of controlling the operation of the synchronization circuitry 210. A source of power to the VDMS device 200 may be one or more batteries, which may be placed in a receptacle for batteries (not shown) in the handgrip portion 204.

The embedded software may reside in software memory (not shown) in the synchronization circuitry 210. The software in software memory may include an ordered listing of executable instructions for implementing logical functions (i.e., “logic” that may be implement either in digital form such as digital circuitry or source code or in analog form such as analog circuitry or an analog source such an analog electrical, sound or video signal), may selectively be embodied in any computer-readable (or signal-bearing) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “computer-readable medium” and/or “signal-bearing medium” is any means that may contain, store, communicate, propagate, or transport the program for use by or in connection with the instruction execution system, apparatus, or device. The computer readable medium may selectively be, for example but not limited to, an electronic, magnetic, optical, electromagnetic, infrared, or semiconductor system, apparatus, device, or propagation medium. More specific examples “a non-exhaustive list” of the computer-readable medium would include the following: an electrical connection “electronic” having one or more wires, a portable computer diskette (magnetic), a RAM (electronic), a read-only memory “ROM” (electronic), an erasable programmable read-only memory (EPROM or Flash memory) (electronic), an optical fiber (optical), and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It will be understood that the foregoing description of numerous implementations has been presented for purposes of illustration and description. It is not exhaustive and does not limit the claimed inventions to the precise forms disclosed. Modifications and variations are possible in light of the above description or may be acquired from practicing the invention. The claims and their equivalents define the scope of the invention.

What is claimed:

1. A virtual display with motion synchronization (“VDMS”) device for displaying messages, the VDMS device comprising:
at least one motion sensor;
synchronization circuitry in signal communication with the at least one motion sensor; and
an array of light sources in signal communication with the synchronization circuitry that are configured to display messages, wherein the array of light sources emits light that forms a message responsive to signals received from the synchronization circuitry.

2. The VDMS device of claim 1, wherein the array of light sources includes at least one line array of light emitting diodes (“LEDs”).

3. The VDMS device of claim 2, wherein the at least one motion sensor is a low-g accelerometer.

4. The VDMS device of claim 3, wherein the low-g accelerometer further includes a standard peripheral interface (“SPI”).

5. The VDMS device of claim 2, wherein the at least one motion sensor is a rate gyroscope.

6. The VDMS device of claim 2, wherein the synchronization circuitry is configured to receive input signals from the at least one motion sensor, and in response produce signals that are transmitted to the array of light sources to generate a message that is displayed by the VDMS device.

7. The VDMS device of claim 6, wherein the synchronization circuitry is configured to receive control information and data from a wireless connection to the VDMS device, wherein the control information and the data are utilized in forming the message.

8. The VDMS device of claim 7, wherein the VDMS device further includes memory in signal communication with the synchronization circuitry.

9. The VDMS device of claim 6, wherein the synchronization circuitry is configured to receive control information and data from a wired data upload connection to the VDMS device, wherein the control information and the data are utilized in forming the message.

10. The VDMS device of claim 9, wherein the VDMS device further includes memory in signal communication with the synchronization circuitry.

11. The VDMS device of claim 2, further including a handgrip attached to the VDMS device that allows a user to impart motion to the VDMS device.

12. The VDMS device of claim 2, further including a self-contained power source.

13. A method for producing messages using an array of light sources positioned in a virtual display with motion synchronization (“VDMS”) device, the method comprising:
imparting motion to the VDMS device to define a display area in which the message will be displayed;
producing signals with a motion sensor responsive to the motion imparted to the VDMS device;
transmitting the signals generated by the motion sensor to synchronization circuitry connected to the light sources; and
generating signals with the synchronization circuitry that are transmitted to the light sources,
wherein the signals transmitted to the light sources cause the light sources to flash and generate a message in the display area.

14. The method of claim 13, wherein the motion sensor is a low-g accelerometer.

15. The method of claim 14, wherein the array of light sources includes at least one line array of light emitting diodes (“LEDs”).

16. The method of claim 15, wherein imparting motion to the VDMS device includes moving the VDMS device at a velocity such that the VDMS device is not visible to the human eye.

17. The method of claim 16, wherein the message generated by the flashing LEDs in the display area appears to the human eye as a steady image.

18. The method of claim 17, wherein the message generated in the display area is predetermined by a user of the VDMS device.

19. The method of claim 18, further including receiving control information and data from a wireless connection to the VDMS device, wherein the control information and the data are utilized in forming the message.

20. The method of claim 18, further including receiving control information and data from a wired data upload connection to the VDMS device, wherein the control information and the data are utilized in forming the message.
